(19) United States
(12) Patent Application Publication
(10) Pub. No.: US 2010/0287689 A1
(43) Pub. Date: Nov. 18, 2010

(54) PROTECTIVE GARMENTS AND ACCESSORIES

(76) Inventor: Jeremiah Sawyer SULLIVAN, San Diego, CA (US)

Correspondence Address: SHEPPARD, MULLIN, RICHTER & HAMPTON LLP, 12275 EL CAMINO REAL, SUITE 200, SAN DIEGO, CA, 92130, US

(21) Appl. No.: 12/778,983

(22) Filed: May 12, 2010

Related U.S. Application Data
(60) Provisional application No. 61/196,737, filed on May 12, 2009.

(51) Int. Cl. A62B 17/00; B32B 37/00; D04B 1/24; D03D 3/00

(52) U.S. Cl. 2/458; 156/60; 66/171; 139/384 R

(57) ABSTRACT

The present invention provides a protective fabric or garment comprising an insulator base layer, a protective layer attached to a body side of the insulator base layer, and one or more protective components attached to selected areas of an outer side of the insulator base layer, wherein each protective component includes at least one protective component layer. Each protective may include fibers having a tensile strength of at least 3 GPa and a modulus of at least 70 GPa. In some embodiments, at least one protective layer is formed with a liquid crystal polymer fiber. In other embodiments, at least one protective layer is formed using a blend of two or more materials selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene.

### RELATED APPLICATIONS

This application claims priority to U.S. Provisional Patent Application No. 61/196,737, filed May 12, 2009, the content of which is hereby incorporated by reference in its entirety.

### TECHNICAL FIELD

The present invention relates generally to protective garments, and more particularly, some embodiments relate to protective garments including particular fibers, fabrics and materials, and methods for making protective garments and accessories.

### DESCRIPTION OF THE RELATED ART

Most protective fabrics, garments, and accessories are generally of minimal effectiveness and of limited comfort. Garments and accessories made of conventional materials that are touted as puncture, laceration, abrasion and/or impact resistant are nearly unwearable, or at least suffer from bulkiness, denseness, rigidity, and, most importantly, ineffectiveness.

Modern wetsuits are thought of as protective garments, and are formed primarily out of neoprene, a closed-cell foam that contains tiny bubbles of nitrogen gas. The nitrogen gas has low thermal conductivity, which reduces heat drawn from the body, and reduces heat drawn from water that becomes trapped between the body and the wetsuit. While some wetsuit manufacturers are incorporating new thermally insulating materials such as wool, nylon, or titanium, in layers with neoprene to reduce wetsuit thickness, modern wetsuits are far from protective against punctures, lacerations, abrasions and impacts, limiting their effectiveness in adverse conditions. Environmental factors such as coral or rocks, wildlife such as barnacles, stingrays or sharks, or even man-made factors such as bullets, knives or other sharp points, can compromise the integrity of a wetsuit, and therefore it's utility.

A drysuit provides at least passive thermal protection while keeping its wearer dry in wet, typically cold, conditions. Drysuits are usually made with a water impermeable layer in addition to a thermal insulation layer, and as such do not “breathe” well (i.e. allow in- or out-passing of air) and can be very uncomfortable for the wearer. The water impermeable layer is commonly made of vulcanized rubber, laminated nylon, butyl rubber, or sealed latex rubber. However, any sharp or forceful object that contacts a conventional drysuit can easily render the drysuit useless.

### BRIEF SUMMARY OF EMBODIMENTS OF THE INVENTION

This document describes protective garments and accessories made from high strength, protective fibers, fabrics and materials, as well as methods for making such protective garments and accessories. In particular, the fabrics are formed of high-strength fibers that can be incorporated with other materials to produce comfortable garments and accessories that are resistant to laceration, abrasion, impact and puncture. The protective garments may include garments for (i) marine use including water sports and activities such as scuba diving, surfing, kite boarding, rescue divers, and (ii) military use for impact-resistant clothing, upholstery and accessories.

In one implementation, protective fibers, fabrics and materials are formed into a wetsuit, in which various specific locations of the wetsuit can include different combinations of the protective fibers, fabrics and materials. In another implementation, the fibers, fabrics and materials are formed into a uniform such as a military battle dress uniform (BDU). In yet another implementation, the protective fibers, fabrics and materials are formed into specific items of clothing such as shirts, pants, or undergarments. These protective fibers, fabrics and materials can also be formed into other items of clothing and accessories including, but not limited to, vests, gloves, socks, shoes, hats, belts, bags, covers, rope and other items.

One embodiment of the invention provides a protective garment comprising an insulator base layer, a layer of protective fabric attached to a body side of the base layer, and one or more protective components attached at an outer side of the base layer at selected areas. Each protective layer may include fibers having a tensile strength of at least 3 GPa and a modulus of at least 70 GPa. In some implementations, at least one of the protective layers is formed with a liquid crystal polymer fiber. The liquid crystal polymer fiber may include a flat weave, knit or other style fabric that is fused to the body side of the insulator base layer. Additionally, the insulator base layer may comprise neoprene or other porous open cell or closed cell flexible foam rubber. The protective components may include a first protective component layer having a different alignment or knit matrix than a second protective component layer.

According to some embodiments described herein, at least one of the protective layers is formed with a protective fiber comprising a meta-aramid fiber. In other embodiments, at least one of the protective layers is formed with a protective fiber comprises a para-aramid fiber. In still further embodiments, two or more materials (e.g., liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene) are blended together to form a yarn, which is then turned into a knit or weave for forming the protective layer.

The protective garment may be formed by knitting or weaving the fibers into an interlocking knitted fabric having a weight of 200-600 denier. In some embodiments, the weight may be as high as 1500 denier. Suitable knits and weaves include without limitation, V-bed, terry, jersey, rib knit, double knit interlock, Rochelle, fabrics with dissimilar backing material, and other knits and weaves. Additionally, the protective garment may feature a combination of knits and weaves. The material is then quilted into multiple softly or semi-connected layers. This semi-loose assembly of softly or semi-connected layers is useful in ‘trapping’ and defeating sharp edged objects like sharks teeth, bullets and shrapnel. The quilted material is then cut into pattern shapes or panels and incorporated into or onto the garment in a manner such as those mentioned herein. The layers of protective material are loosely fused together by stitching, molding or layering in with a soft flotation material such as foam, gel or other thin buoyant material. The protective quilted material can be a simple pattern of shapes with small gaps between the panels to allow flexibility of the substrate material. Alternatively, the protective quilted material can be patterned to replicate the appearance of human musculature, again with gaps between the sections (for flexibility of the substrate material), giving the wearer of the suit a very fit athletic appearance. For wetsuit embodiments, the suit is sleek and fits close to the body to limit drag in the water. In particular, the layers of protective material are loosely fused together by stitching, molding or layering in with a soft flotation material such as foam, gel or other thin buoyant material.

Further embodiments of the invention feature a method of manufacturing a protective garment comprising the steps of: (i) forming an insulator base layer; (ii) forming a protective layer and attaching the layer to a body side of the insulator base layer; and (iii) forming one or more protective components, wherein each protective component includes at least one protective component layer; and (iv) attaching the one or more protective components to selected areas of an outer side of the insulator base layer. Forming the protective layers (i.e., protective layer and protective component layer(s)) may comprise forming a protective fiber, cutting the protective fiber, and knitting or weaving the fibers to form the protective fabric. At least one of the protective layers may be formed using a blend of two or more materials selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene. Each of the protective layers may include fibers having a tensile strength of at least 3 GPa and a modulus of at least 70 GPa.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIGS. 1A and 1B illustrate a wetsuit with at least portions formed with a protective fabric, in accordance with an embodiment of the invention.

FIGS. 2A-D illustrate cross sections of various implementations of a wetsuit having a protective component.

FIG. 3 illustrates a military web gear having at least portions formed with a protective fabric, in accordance with an embodiment of the invention.

FIGS. 4A-D illustrate cross sections of various implementations of material for web gear.

FIG. 5 illustrates a military vest and related accessories having at least portions made with protective fabric, in accordance with an embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward protective garments and accessories made from high strength, protective fibers (hereinafter referred to generally as “protective fibers”), having any of a number of desirable properties. Methods for manufacturing such protective garments and accessories are also provided. In a particular implementation, one or more fibers from a selected group of fibers can be knitted or woven into a fabric, combined with other fibers or materials, and applied or otherwise used as a protective component of a garment or accessory. The protective component provides a wearer of the protective garment with great resistance to impacts such as the bite of a shark or in the form of a bullet. In the case of a shark bite, the protective garment generally protects the wearer from potential laceration, abrasion, impact and puncture injuries. Example garments may include without limitation, wetsuits, drysuits, uniforms, vests, flightsuits, pullovers, rash guards, swim skin, jackets, coveralls, and other garments. Example accessories may include without limitation, gear bags, pouches, pockets, harnesses, webgear, hats, helmets, headgear, shoes, skate shoes, socks, booties, cuffs, armbands, gloves, tents, armor carriers, belts, bags, covers, rope and other accessories.

Protective Fibers

According to some embodiments of the invention, the protective fiber comprises a meta-aramid fiber, such as Nomex™. Meta-aramid fibers are dry spun and generally exhibit: (i) high tenacity (tensile stress when expressed as force per unit linear density of the unstrained specimen), (ii) high modulus (the ratio of change in stress—in force per unit linear density or force per unit area of the original specimen—to change in strain—i.e. percentage contraction or elongation of the specimen—following removal of crimp from the specimen being tested), and (iii) high heat resistance. Additionally, meta-aramid fibers provide heat and flame resistance, anti-static behavior, and resistance to industrial oils, solvents, oxidation, and most chemicals. In some implementations, a meta-aramid fiber is formed into a fabric and used as a primary barrier in garments and accessories. Such a meta-aramid fiber may be combined with other fibers and materials to achieve desired effects in accordance with various embodiments of the invention.

According to further embodiments of the invention, the protective fiber comprises a para-aramid fiber, such as Kevlar™ or Twaron™. Para-aramid fibers are dry-wet or wet spun, and exhibit very high tenacity, high modulus and high heat resistance. Other embodiments may include a protective fiber in the form of a liquid crystal polymer fiber such as Vectran™. Liquid crystal polymer fibers are dry spun, and exhibit high strength, high modulus, and high heat resistance, as well as high resistance to moisture and chemicals. Further, liquid crystal polymer fibers generally retain these properties in hostile environments. Other example fibers that can be used as a protective fiber include, but are not limited to, polyphenylenebenzimidazole (PBI), polybenzoxazole (PBO), and polyethylene.

According to various exemplary protective garments set forth herein, each protective fiber is made in 100-2500 denier filament, with an exemplary weight of about 200-600 denier. Each protective garment comprises one or more protective fibers that are woven, knitted or otherwise formed into a fabric (hereinafter “protective fabric”). In implementations where two or more protective fibers are employed, each protective fiber can have the same denier. Alternatively, protective fibers of different deniers can be used. By way of example, two or more protective fibers can be woven or knitted into separate protective fabrics and combined in layers or patterns of layers. One or more layers of protective fabrics can be bonded, glued, stitched, or fused together, or bonded, glued, stitched or fused to a base garment or accessory material such as neoprene, cotton, nylon, or the like. A selected layer of fabric may be adjusted to various biases with the other layers. Flipping selected layers in the stack can be desirable to achieve certain desired properties. Additionally, two or more of the materials described herein for making a protective fiber may be blended together to form a yarn, which is then turned into a knit or weave. Such materials include, but are not limited to, Vectran™ (liquid crystal polymer), Nomex™ (meta-aramid), Kevlar™ (para-aramid), Twaron™ (para-aramid), nylon, olefin, s-glass, elastic, spandex, polyethylene, diamond tough nylon, Zylon™ (thermoset polyurethane synthetic polymer material), Technora™ (aromatic copolyamid), Spectra™ (extended-chain polyethylene) and metallic fibers.

Table 1 presents exemplary ranges of characteristics of the protective fibers used in any number of implementations described herein:

TABLE 1

| | Creep | Strength | Modulus | CTE | Density | Moisture | Elong/Break | Max T |
|---|---|---|---|---|---|---|---|---|
| | % logt | GPa | GPa | um/m/C | g/cm³ | % | % | ° C. |
| Preferred | 0-0.1 | 2.9-10 | 50-200 | −4.5-−5.0 | .5-1.5 | 0.1-5 | 2.5-5.0 | 100-300 |
| Range | | | | | | | | |

Other Materials

In some embodiments of the invention, protective garments and accessories can be made with other materials integrated with the protective fibers and fabrics set forth herein. For example, a protective garment such as a wetsuit, rash guard and booties (hereinafter, “wetsuit”) can be formed with an insulator layer such as neoprene, a synthetic rubber produced by polymerization of chloroprene. In one wetsuit implementation, the insulator layer is a closed cell neoprene having tiny air pockets that are filled with nitrogen as an insulation agent. In other implementations, the neoprene can be combined with spandex or other elastic material for improved flexibility, stretchability, comfort and fit. The neoprene can also be combined with nylon or other stable base layer for better integrity and stability.

Protective garments and accessories can also be made with natural materials such as cotton, wool, and natural rubber. Protective garments and accessories may also be made with synthetic materials including polymers and elastomers, such as rayon and nylon. In some implementations, a protective garment and/or accessory may be coated with a coating such as plastic, resin or rubber to provide desired properties such as water, gas, oil or air impermeability, or resistance to hostile factors such as mold, powders, or residues. The coating can be uniformly or selectively applied to a garment and/or accessory by any of a number of conventional coating or application techniques such as air spraying, liquid spray coating, dip coating, roll coating, powder coating, coil coating, fluidized bed coating, curtain coating, thin film application, lamination, heat pressing and/or other conventional coating or application techniques.

In some embodiments, the protective fabric may also include a thixotropic material that is selectively applied to specific areas to make those areas further resilient. Thixotropic materials undergo a change in viscosity when the material is exposed to shear stress. Example thixotropic materials include gels and colloids. In further embodiments, anti-thixotropic materials can also be selectively applied to selected areas of the protective fabric. Anti-thixotropic materials increase in consistency, or resistance to flow, according to increased time of shear. Anti-thixotropic materials have a low solids content (1-10%) and are flocculated, i.e. the solid particles aggregate into clumps or masses within their host fluid. Additional embodiments may feature the use of dilatant materials. Dilatant materials are deflocculated, and characterized by their ability to aggregate or mass into clumps.

The materials described above, and others, may form a substrate onto which various fillers, binders and other materials can be applied, bonded or coated. The substrate may be coated by employing any of a number of conventional coating or application techniques including those described herein.

Knit Types/Weave Types

According to various embodiments of the invention, protective fabrics are made of protective fibers knitted into a fabric. In further embodiments, protective fibers may be woven, braided, or otherwise formed into a fabric. In knitted configurations, a protective fabric is formed of a circular-knit or flat-knit jersey stitch, in which the loops of plain stitching intermesh in only one direction. A jersey-style protective fabric can be formed to be stretchable in two directions. In other implementations, a protective fabric is formed of a terry knit, i.e. having uncut loops of protective fiber on one or both sides. A protective fabric can be ribbed, crimped, flat, double knitted, or ring spun. In specific implementations, a protective fiber may be produced in 2″-30″ tubular form, or 4″-60″ flat form. Such a protective fiber may have a produced weight of approximately 0.5-1.5 lbs. per square yard.

Fabrics/Composition

The protective fabric described herein can be formed to exhibit specific properties, such as being stretchable in four-ways or two-ways, or alternatively to be stiff and inelastic. In some implementations, a protective fiber can be interwoven or integrated with elastic or other stretchable material for added flexibility, or with one or more other protective fibers to produce a protective fabric with specific combinations of properties such as strength and flame resistance.

Products

As discussed herein, protective garments and accessories may include, but are not limited to, wetsuits, drysuits, uniforms, vests, flightsuits, pullovers, rash guards, jackets, coveralls, gear bags, pouches, pockets, harnesses, webgear, hats, helmets, headgear, shoes, skate shoes, socks, booties, cuffs, armbands, gloves, tents, armor carriers, belts, bags, covers, rope and other items.

In one specific implementation, a shirt is formed of 100% liquid crystal polymer fiber, implemented in a fabric that is formed in a jersey knit. In alternative implementations, the shirt can be formed with 2-5% elastic. The shirt may be formed of one layer of protective fabric that is stitched or sewn in either a long-sleeve or a short-sleeve configuration. In further implementations, another layer of fabric made from liquid crystal polymer fiber can be sewn, bonded, or fused to specific areas or surfaces of the shirt, either inside or outside of the base protective fabric. A pigment or dye can also be applied to the fabric of the shirt to give it a desired color.

In accordance with another specific implementation, protective fibers and protective fabrics can be used for a water-oriented application. In such an application, the protective fibers and fabrics can be integrated with a wetsuit, with a drysuit, or employed in a garment worn over or under a wetsuit or drysuit. In addition to the insulation and/or water-impermeable qualities, the protective fibers and fabrics provide laceration, abrasion, impact and puncture resistance.

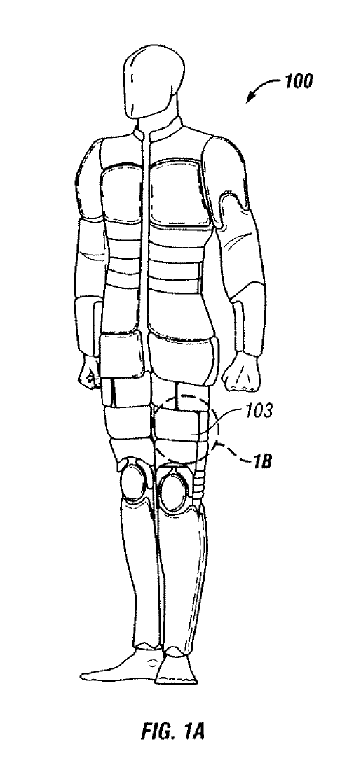

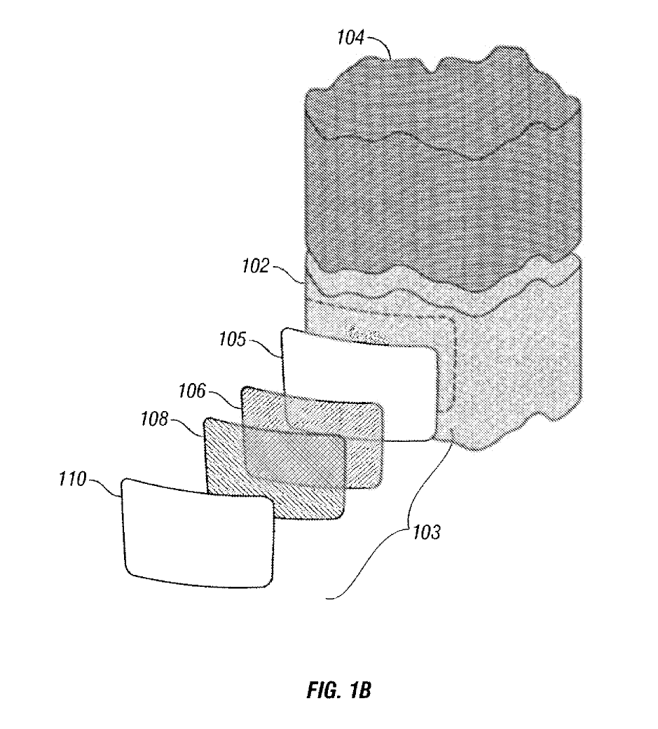

FIGS. 1A and 1B illustrate a wetsuit 100 including a plurality of protective layers 102, 104. In the illustrated example, the wetsuit 100 is formed of an insulator base layer 102, a protective layer 104, and one or more protective components 103. By way of example, the insulator base layer 102 may comprise neoprene or other porous open cell or closed cell flexible foam rubber. As illustrated, the protective layer 104 may be attached to a body side of the insulator base layer 102. The protective layer 104 can be formed to include any of the protective fibers described herein. In a specific implementation, the protective layer 104 includes liquid crystal polymer fiber in a flat weave, which is fused to the body side of the insulator base layer 102.

With further reference to FIGS. 1a and 1B, the one or more protective components 103 are selectively positioned with respect to the insulator base layer 102. Each of these protective components 103 may be formed with one or more layers of protective fabric in layered arrangement with other materials or coatings. For example, a protective component 103 can include a base layer 105, a first protective component layer 106 and a second protective component layer 108. The protective component 103 may further include an outer layer 110 of material and/or coating. In some embodiments, the first protective component layer 106 may have a different alignment or knit matrix than the second protective component layer 108, for added strength and directional protection.

In an exemplary implementation, the first and second protective component layers 106 and 108 are formed of a liquid crystal polymer fiber and fabric, although other fibers can be employed without departing from the scope of the invention. For example, the first and second protective component layers 106 and 108 may be formed from meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, extended-chain polyethylene, or any combination of these materials. The protective component 103 may include any number of protective component layers, in any number of arrangements or knit matrices.

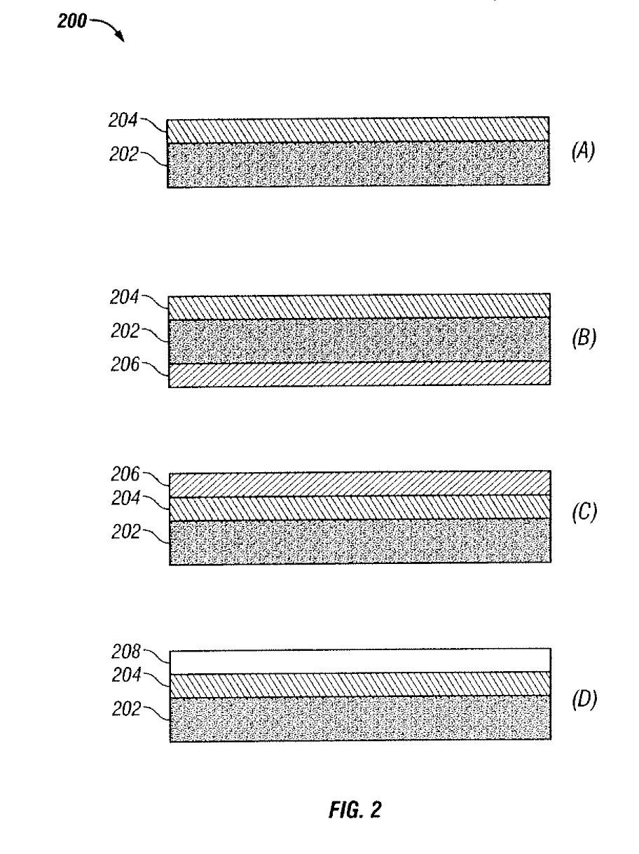

FIGS. 2A-D illustrate cross sections of various implementations of a wetsuit having a protective component in accordance with the principles of the invention. In particular, FIG. 2A depicts a cross section of a wetsuit having an insulator base layer 202 and a protective fabric layer 204 disposed on the insulator base layer 202. The protective fabric layer 204 can be bonded, fused, sewn, stitched or thermally attached to the insulator base layer 202. In the illustrated embodiment, the protective fabric layer 204 forms the outer side of the protective garment. In other embodiments, the protective fabric layer 204 may form the body side of the protective garment, i.e., facing toward the wearer's body.

In the embodiment depicted in FIG. 2B, a first protective layer 204 is formed on a first side of an insulator base layer 202, and a second protective layer 206 is formed on a second side of the insulator base layer 202. One or both protective layers 204 and 206 can be cut or crimped, or formed as a velour fabric, for desired comfort.

FIG. 2C depicts a cross section of a wetsuit having an insulator base layer 202, a first protective layer 204 and a second protective layer 206. The first and second protective layers 204 and 206 can be knitted using one or more protective fibers, and each layer can include one or more other materials, coatings or agents. In some implementations, the first and second protective layers 204 and 206 are knitted fabrics, and are configured to offset a knit orientation. For example, the second protective layer 206 can be rotated 5-175 degrees from a knit orientation of the first protective layer 204.

FIG. 2D illustrates a cross section a wetsuit having an insulator base layer 202, a first protective layer 204 and a coat layer 208. The coat layer 208 may comprise a thixotropic material, an anti-thixotropic material, a water barrier, or other type of coating or sealant. In some embodiments, the coat layer 208 may provide stability and/or enhanced laceration, abrasion, impact and puncture resistance to the first protective layer 204. The coat layer 208 may also exhibit properties to deflect or absorb sonar waves or other forms of water-based imaging and detection, for providing the material with stealth characteristics.

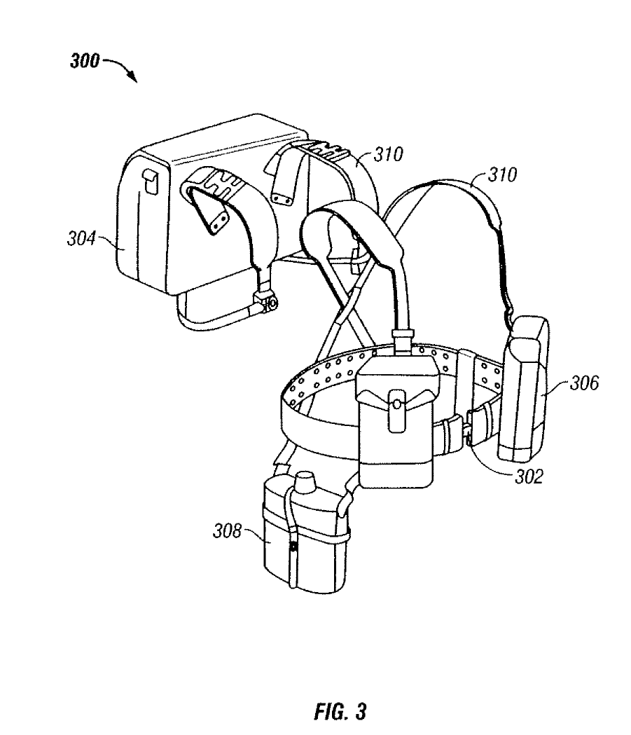

FIG. 3 illustrates military web gear 300 having at least portions made with protective fabric. The web gear 300 may be employed for tactical military or police operations, as well as for hunting, camping, and other recreation. In the illustrated embodiment, the web gear 300 includes a belt 302, a backpack 304, pouches 306, holsters 308, and straps 310. Other web gear 300 may include without limitation, vests, containers, buckles, and armor carriers. The components of the web gear 300 can be made using 100% protective fibers as material, or multiple layers of protective fabrics. Alternatively, the material that forms the web gear 300 can be made of less than 100% protective fibers mixed with other materials. Where one or more layers of protective fabrics are used, the web gear 300 can include integrated or interstitial layers of comfort fabrics such as cotton, nylon, or other material such as foam, rubber, etc.

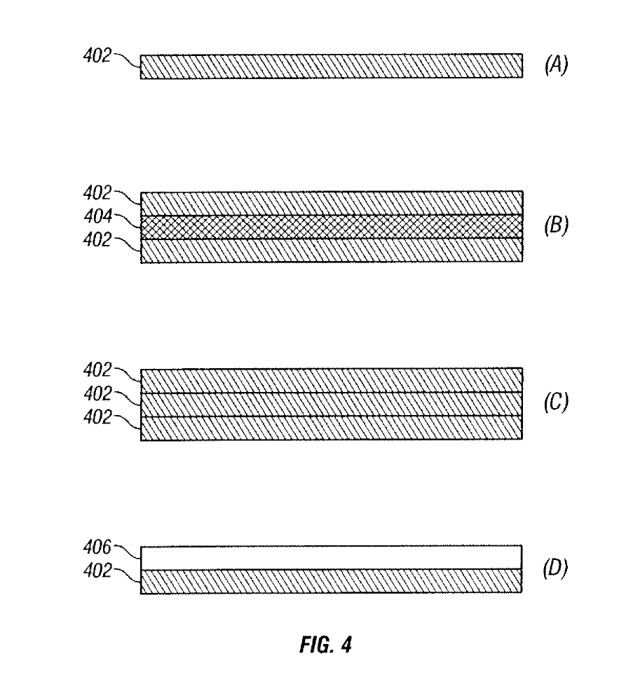

FIGS. 4A-D depict cross sections of various implementations of material for web gear. Referring to FIG. 4A, the web gear can be made with a protective layer 402 that includes 80-100% protective fiber formed in a fabric, such as a knitted fabric, woven fabric, etc. As illustrated in FIG. 4B, the web gear material can include two or more protective layers 402 formed on either side of a base layer 404 such as cotton, neoprene, ballistic nylon, or other base material. According to additional embodiments, one or more protective layers 402 can be covered on each outer facing side by a base layer 404.

FIG. 4C illustrates a cross section of material for web gear having three protective layers 402 layered together. Each protective layer 402 is formed with a percentage of protective fiber, and can be bonded, woven, knitted, glued, tacked or otherwise attached to adjacent layers. If provided as knitted fabrics, the protective layers 402 can be juxtaposed in a flipped or offset arrangement for added directional integrity or strength.

FIG. 4D depicts a cross section of material for web gear having a protective layer 402 and a coat layer 406. The coat layer 406 may comprise a thixotropic material, an anti-thixotropic material, a water barrier, or other type of coating or sealant. In some embodiments, the coat layer 406 provides stability and/or enhanced laceration, abrasion, impact and puncture resistance to the first protective layer 402. The coat layer 406 can include reflective material, or other material with specific desired properties.

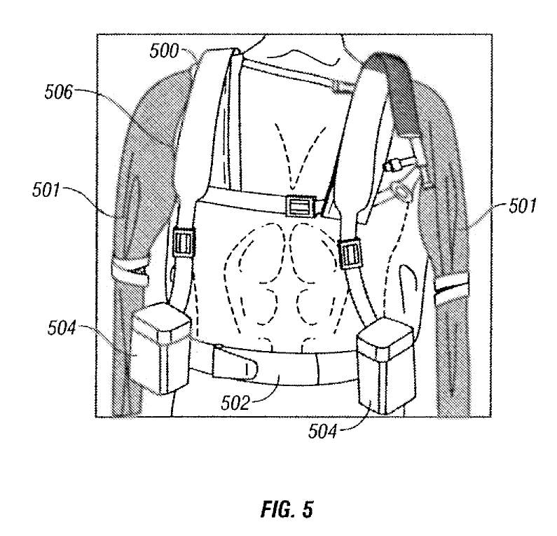

FIG. 5 illustrates a military vest 500 and related accessories having at least portions made with protective fabric. The military vest 500 and related accessories may be employed for tactical military or police operations, as well as for hunting, camping, and other recreation. In the illustrated embodiment, the military vest 500 includes a plurality of protective layers of fabric in the chest and abdominal regions, as well as single-layer protective sleeves 501. The accessories include a belt 502, holsters 504, and straps 506. The military vest 500 and related accessories can be made using 100% protective fibers as material, or multiple layers of protective fabrics. Alternatively, the material can be made of less than 100% protective fibers mixed with other materials. Where one or more layers of protective fabrics are used, the military vest 500 and related accessories can include integrated or interstitial layers of comfort fabrics such as cotton, nylon, or other material such as foam, rubber, etc.

Method of Manufacture

According to some embodiments, method of manufacturing a protective garment comprises the steps of: (i) forming an insulator base layer; (ii) forming a protective layer and attaching the layer to a body side of the insulator base layer; and (iii) forming one or more protective components, wherein each protective component includes at least one protective component layer; and (iv) attaching the one or more protective components to selected areas of an outer side of the insulator base layer. Forming the protective layers (i.e., protective layer and protective component layer(s)) may comprise forming a protective fiber, cutting the protective fiber, and knitting or weaving the fibers to form the protective fabric. At least one of the protective layers may be formed using a blend of two or more materials selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene. Each of the protective layers may include fibers having a tensile strength of at least 3 GPa and a modulus of at least 70 GPa.

The protective garment may be formed by knitting or weaving the fibers into an interlocking knitted fabric having a weight of 200-600 denier. Suitable knits and weaves include without limitation, V-bed, terry, jersey, rib knit, double knit interlock, Rochelle, and other knits and weaves. Additionally, the protective garment may feature a combination of knits and weaves. The material is then quilted into multiple softly or semi-connected layers. This semi-loose assembly of softly or semi-connected layers is useful in ‘trapping’ and defeating sharp edged objects like sharks teeth, bullets and shrapnel. The quilted material is then cut into pattern shapes or panels and incorporated into or onto the garment in a manner such as those mentioned herein. The layers of protective material are loosely fused together by stitching, molding or layering in with a soft flotation material such as foam, gel or other thin buoyant material. The protective quilted material can be a simple pattern of shapes with small gaps between the panels to allow flexibility of the substrate material. Alternatively, the protective quilted material can be patterned to replicate the appearance of human musculature, again with gaps between the sections (for flexibility of the substrate material), giving the wearer of the suit a very fit athletic appearance. For wetsuit embodiments, the suit is sleek and fits close to the body to limit drag in the water. In particular, the layers of protective material are loosely fused together by stitching, molding or layering in with a soft flotation material such as foam, gel or other thin buoyant material.

The protective fabrics described herein can be assembled by a cut and sew operation. Cutting can be achieved by mechanical operations such as using knife blades. In some embodiments, heat cutting may be employed whereby a cutting blade is heated to a temperature above the zero-strength temperature of the fiber.

The resultant fabric or product made from one or more protective fibers can include texture or patterns. The fabric or product may also be manufactured to exhibit other features such as ultraviolet protection, dynamic toughness, good flex fatigue. In addition, the fabric or product may be easy to splice, cut or bond with other fabrics or materials.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. These illustrations and their accompanying description should not be construed as mandating a particular architecture or configuration.

1. A protective garment comprising:
an insulator base layer;
a protective layer attached to a body side of the insulator base layer; and
one or more protective components attached to selected areas of an outer side of the insulator base layer;
wherein each protective component includes at least one protective component layer.

2. The protective garment of claim 1, wherein each protective layer includes fibers having a tensile strength of at least 3 GPa and a modulus of at least 70 GPa.

3. The protective garment of claim 1, wherein at least one protective layer is formed with a liquid crystal polymer fiber.

4. The protective garment of claim 3, wherein the liquid crystal polymer fiber includes a flat weave or knit that is fused to the body side of the insulator base layer

5. The protective garment of claim 1, wherein the insulator base layer comprises neoprene or other porous open cell or closed cell flexible foam rubber.

6. The protective garment of claim 1, wherein the at least one protective component layer includes a first protective component layer having a different alignment or knit matrix than a second protective component layer.

7. The protective garment of claim 1, wherein at least one protective layer is formed with a protective fiber comprising a meta-aramid fiber.

8. The protective garment of claim 1, wherein at least one protective layer is formed with a protective fiber comprises a para-aramid fiber.

9. The protective garment of claim 1, wherein the protective layer includes fibers having a weight of 200-600 denier.

10. The protective garment of claim 1, wherein at least one protective layer is formed using a blend of two or more materials selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene.

11. A method of manufacturing a protective garment, the method comprising:
forming an insulator base layer;
forming a protective layer and attaching the layer to a body side of the insulator base layer
forming one or more protective components, wherein each protective component includes at least one protective component layer; and
attaching the one or more protective components to selected areas of an outer side of the insulator base layer.

12. The method of claim 11, wherein each protective layer includes fibers having a tensile strength of at least 3 GPa and a modulus of at least 70 GPa.

13. The method of claim 11, wherein forming the protective layer comprises forming a protective fiber, cutting the protective fiber, and knitting or weaving the fibers to form the protective layer.

14. The method of claim 11, wherein at least one protective layer is formed with a liquid crystal polymer fiber.

15. The method of claim 14, wherein the liquid crystal polymer fiber includes a flat weave or knit that is fused to the body side of the insulator base layer

16. The method of claim 11, wherein the insulator base layer comprises neoprene or other porous open cell or closed cell flexible foam rubber.

17. The method of claim 11, wherein the one or more protective components include a first protective component layer having a different alignment or knit matrix than a second protective component layer.

18. The method of claim 11, wherein at least one protective layer is formed with a protective fiber comprising a meta-aramid fiber.

19. The method of claim 11, wherein at least one protective layer is formed with a protective fiber comprises a para-aramid fiber.

20. The method of claim 11, wherein the protective fiber includes fibers having a weight of 200-600 denier.

21. The method of claim 11, wherein at least one protective layer is formed using a blend of two or more fiber materials.

22. The method of claim 21, wherein the two or more fiber materials are selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene.
